(19) United States
(12) Patent Application Publication
(10) Pub. No.: US 2013/0025860 A1
(43) Pub. Date: Jan. 31, 2013

(54) Composite Particulates and Methods Thereof for High Permeability Formations

(71) Applicants: Ian D. Robb, Lawton, OK (US); Feng Liang, Duncan, OK (US); Bradley L. Todd, Duncan, OK (US)

(72) Inventors: Ian D. Robb, Lawton, OK (US); Feng Liang, Duncan, OK (US); Bradley L. Todd, Duncan, OK (US)

(73) Assignee: Halliburton Energy Services, Inc., Houston, TX (US)

(21) Appl. No.: 13/190,509

(22) Filed: Jul. 26, 2011

(51) Int. Cl. E21B 43/00; C09K 8/56; C09K 8/60; C09K 8/02

(52) U.S. Cl. 166/279; 507/120; 507/225

(57) ABSTRACT

Composite particulates for use in high permeability subterranean formations may contain, at least, a gel particulate having a solid particulate incorporated. Some methods of using the diverting agent may include introducing a treatment fluid comprising a base fluid and a diverting agent into at least a portion of a subterranean formation and allowing the diverting agent to bridge fractures, provide fluid loss control, seal the rock surfaces for fluid diversion, or plug an area along the annulus of a wellbore.

### BACKGROUND

The present invention relates to diverting agents and methods of their use in high permeability subterranean formations.

Solid and gelled particulates are common additives employed in subterranean operations. For instance, water-hydrolysable materials such a poly(lactic) acid or polymeric gels, may be used in subterranean operations as bridging agents, fluid loss control particles, diverting agents, filter cake components, drilling fluid additives, cement additives, and the like. In some cases, the additive or a combination of additives are introduced into at least a part of the subterranean formation as components of a treatment fluid to control the flow of fluids into and out of portions of the subterranean formation.

Subterranean treatment fluids are commonly used in drilling, stimulation, sand control, and completion operations. As used herein, the term “treatment,” or “treating,” refers to any subterranean operation that uses a fluid in conjunction with a desired function and/or for a desired purpose. The term “treatment,” or “treating,” does not imply any particular action by the fluid.

Numerous additives are used in the art to help to divert fluids in low permeability subterranean operations, i.e., formations with a permeability less than about 0.1 darcy (D). These conventional additives fall short in high permeability formations where pore throats are too wide for the additives to bridge or plug, especially at differential pressures greater than about 50 psi.

Additionally, the use of conventional additives may give rise to other problems. In some instances, the diverting additives used may be toxic and thus may harm the environment; this problem may be aggravated because many additives are poorly degradable or nondegradable within the environment. Due to environmental regulations, costly procedures often must be followed to dispose of the treatment fluids containing such compounds, ensuring that they do not contact the marine environment and groundwater. In addition, removal of some known materials require hydrocarbon treatments, high temperature, and/or a large volume of under-saturated liquid (such as for the removal of salts).

Further, conventional diverting additives may require a second treatment to restore permeability in a given zone. In some cases, the second treatment may need to be extensive when the conventional diverting additive becomes incorporated within the matrix of the subterranean formation.

Thus, it is desirable to have a diverting agent that is effective in high permeability formations, that poses little or no risk to the environment, and that is able to degrade over time and restore lost permeability without additional treatment.

### SUMMARY OF THE INVENTION

The present invention relates to diverting agents and methods of their use in high permeability subterranean formations. Methods that, more specifically, relate to bridging fractures, providing fluid loss control, sealing the rock surfaces for fluid diversion, or plugging an area along the annulus of a wellbore,

One embodiment of the present invention provides for a method comprising: introducing a treatment fluid comprising a base fluid and a composite particulate into a wellbore penetrating a subterranean formation, wherein the composite particulate comprises a gel particulate having a solid particulate incorporated therein; and allowing the composite particulate to bridge a fracture, provide fluid loss control, seal a rock surface for fluid diversion, or plug a void within the wellbore or the subterranean formation.

One embodiment of the present invention provides for a method comprising: introducing a treatment fluid comprising a base fluid and a composite particulate into a wellbore penetrating a subterranean formation, wherein the composite particulate comprises a gel particulate having a solid particulate incorporated therein, and wherein the gel particulate is degradable; allowing the composite particulate to bridge a fracture, provide fluid loss control, seal a rock surface for fluid diversion, or plug a void within the wellbore or the subterranean formation; and allowing the gel particulate to degrade over time in the subterranean formation such that the composite particulate at some time no longer functions to bridge the fracture, provide fluid loss control, seal the rock surface for fluid diversion, or plug the void within the wellbore or the subterranean formation.

One embodiment of the present invention provides for a composite particulate comprising a gel particulate having a solid particulate incorporated therein.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to those skilled in the art and having the benefit of this disclosure.

FIG. 1 illustrates passage of an aqueous fluid containing various diverting agents over time with increasing pressure.

FIG, 2 illustrates passage of an aqueous fluid containing various diverting agents over time with increasing pressure.

FIG, 3 illustrates a schematic of an apparatus for measuring the fluid loss as a function of time and/or pressure,

### DETAILED DESCRIPTION

The present invention relates to diverting agents and methods of use in high permeability subterranean formations. Methods that, more specifically, relate to bridging fractures, providing fluid loss control, sealing the rock surfaces for fluid diversion, or plugging an area along the annulus of a wellbore,

The present invention provides composite particulates that, as used herein, are gel particulates containing at least one solid particulate therein. Of the many advantages, the present invention provides composite particulates that are particularly useful for reversible, environmentally-friendly fluid diversion, fluid loss control, plugging, or sealing in high permeability portions of subterranean formations. Further, the composite particles may be degradable, which may eliminate the need for a second treatment fluid to restore permeability to a zone within a subterranean formation, thereby reducing cost and time of implementation.

Permeability, the ability of a porous material to transmit fluids, is measured in darcy (D). Generally, high permeability formations have a permeability of greater than about 0.5 D. In subterranean formations, the permeability is generally related to the average pore throat size. Thus, while darcy is the standard unit of measurement for permeability, high permeability formations may also be indicated by an average throat diameter of larger than about 20 μm. Composite particulates of the present invention are designed to be particularly effective in bridging and/or plugging pore throats of high permeability formations and maintaining said bridge or plug at operating pressures, e.g., a differential pressure greater than about 200 psi.

The present composite particulates may be formed by chopping a gel comprising a plurality of solid particulates into composite particles that comprise a gel particulate with a solid particulate therein. As is illustrated in the examples, the composite particulates of the present invention may be more effective at reducing fluid flow through voids in high permeability areas of a subterranean formation than either gel particulates alone or solid particulates admixed with gel particulates, a result which was unexpected. Without being limited by theory, it is believed that the solid particulate within the gel particulate may provide stability and strength to the composite particulate, which is especially important for high permeability formations that may require larger particulates to seal larger void spaces. When a degradable gel particulate is used, the composite particulates may be used to temporarily control fluid flow. Further, gel particulates that degrade because of the local environment downhole, provide the added benefit that a second treatment fluid need not be introduced to remove a composite particulate installation.

While a composite particulate of the present invention may be applicable to low and medium permeability subterranean formations, the composite particulates may be preferably suited for high permeability regions of a subterranean formation or within a wellbore. Preferable examples include, but are not limited to, subterranean formations where at least a portion of the formation is a fractured shale, a rubblized zone, a high permeability formation, or a loosely consolidated formation such as a sand formation. Further, the composite particles may be applicable for plugging or bridging voids in man-made installations within a wellbore or subterranean formation, including, but not limited to, gravel packs, proppant packs, screens, slots and ports within wellbore tools or casings, gaps between wellbore tools and between wellbore tools and the wellbore (cased or uncased); and the like. High permeability may be characterized as a permeability ranging from a lower limit of about 0.5 D, 1 D, 10 D, 50 D, or 100 D to an unlimited upper limit. In some embodiments, the high permeability formation may even exhibit a permeability of about 250 D or more. While the upper limit of permeability is believed to be unlimited, formations where the composite particle may be applicable include formations with a high permeability of about 1000 D, 500 D, 250 D, 100 D, or 50 D. The permeability of the subterranean formation may range from any lower limit to any upper limit and encompass any subset between the upper and lower limits. Further, high permeability may be characterized by the width of a void or pore throat which, in its smallest dimension, may range from a lower limit of about 10 μm, 25 μm, 50 μm, 100 μm, or 250 μm to an upper limit of about 1 mm, 500 μm, 250 μm, 100 μm, or 50 μm, and wherein the width may range from any lower limit to any upper limit and encompass any subset between the upper and lower limits.

It should be noted that when “about” is provided at the beginning of a numerical list, “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit. Whenever a range of values is given, any subset of that range (between the highest and lowest point) is an acceptable alternative range in the embodiments of the present invention.

Composite particulates of the present invention generally comprise a gel particulate having a solid particulate incorporated therein. Generally, composite particulates of the present invention may be produced by chopping a gel containing solid particulates into gel particulates containing at least one solid particulate, i.e., a composite particulate. As used herein, “gel” refers to a viscoelastic or semi-solid, jelly-like state of matter resulting from an interconnected assembly of macromolecules having temporary or permanent cross links and exhibiting an apparent yield point. It should be noted that chopping may occur by a variety of methods known to one skilled in the art including, but not limited to, extruding through a die, a filter, or the like; high speed mixing and/or chopping with a homogenizer, blender, emulsifier, or the like; sonicating or the like; and any combination thereof.

In some embodiments, the composite particulate may be produced by suspending a solid particulate in fluid containing a gelling agent. The gelling agent may be polymerized or crosslinked resulting in a gel containing solid particulates. Then, the gel may be chopped to yield composite particulates. As used herein, the term “gelling agent” refers to the precursors used to form a gel including, but not limited to, monomers, partially polymerized monomers, partially crosslinked monomers, cross linking agents, and any combination thereof.

in some embodiments, the solid particulates added to the gelling agent may be multiple solid particulates of varying composition, diameter, and/or shape. In some embodiments, a composite particulate may comprise a gel particulate and a plurality of solid particulates.

Composite particulates of the present invention may have a diameter range from a lower limit of about 2.5 microns, 5 microns, 10 microns, 100 microns, 0.5 mm, or 1 mm to an upper limit of about 10 mm, 5 mm, 1 mm, 0.5 mm, 100 microns, or 10 microns, and wherein the diameter may range from any lower limit to any upper limit and encompass any subset between the upper and lower limits.

In some embodiments, a solid particulate may have a diameter range from a lower limit of about 1 micron, 2.5 microns, 5 microns 10 microns, 50 microns, 100 microns, 0.5 mm, 1 mm to an upper limit of about 5 mm, 2.5 mm, 1 mm, 0.5 mm, 100 microns, or 10 microns, and wherein the diameter may range from any lower limit to any upper limit and encompass any subset between the upper and lower limits,

Solid particulates suitable for use in the present invention may be nondegradable or degradable. Suitable solid particulates include, but are not limited to, sand, shale, bauxite, calcium carbonate, magnesium carbonate, calcium oxide, ceramic materials, glass materials, polymer materials, oil-soluble resins, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite solid particulates, and combinations thereof. Suitable composite solid particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof.

Suitable degradable materials that may be used as solid particulates in conjunction with the present invention include, but are not limited to, degradable polymers, dehydrated compounds, and/or mixtures of the two. Examples of suitable degradable solid particulates may be found in U.S. Pat. Nos. 7,036,587; 6,896,058; 6,323,307; 5,216,050; 4,387,769; 3,912,692; and 2,703,316, the relevant disclosures of which are incorporated herein by reference. As used herein, the term “degradable” should be taken to refer to degradation, which may be the result of, inter alia, a chemical reaction, a thermal reaction, an enzymatic reaction, or a reaction induced by radiation. Degradable materials may include, but not be limited to dissolvable materials, materials that deform or melt upon heating such as thermoplastic materials, hydrolytically degradable materials, materials degradable by exposure to radiation, materials reactive to acidic fluids, or any combination thereof. In some embodiments, a degradable solid particulate may be degraded by temperature, presence of moisture, oxygen, microorganisms, enzymes, pH, free radicals, and the like. In some embodiments, degradation may be initiated in a second treatment fluid introduced into the subterranean formation at some time when diverting is no longer necessary. In some embodiments, degradation may be initiated by a delayed-release acid, such as an acid-releasing degradable material or an encapsulated acid, and this may be included in the treatment fluid so as to reduce the pH of the treatment fluid at a desired time, for example, after introduction of the treatment fluid into the subterranean formation.

In choosing the appropriate degradable material, one should consider the degradation products that will result. Also, these degradation products should not adversely affect other operations or components. For example, a boric acid derivative may not be included as a degradable material in the well drill-in and servicing fluids of the present invention where such fluids use guar as the viscosifier, because boric acid and guar are generally incompatible. One of ordinary skill in the art, with the benefit of this disclosure, will be able to recognize when potential components of a treatment fluid of the present invention would be incompatible or would produce degradation products that would adversely affect other operations or components.

Suitable examples of degradable polymers for a solid particulate of the present invention that may be used include, but are not limited to, polysaccharides such as cellulose; chitin; chitosan; proteins; orthoesters; aliphatic polyesters; poly(lactide); poly(glycolide); poly(c-caprolactone); poly(hydroxybutyrate); poly(anhydrides); aliphatic polycarbonates; poly(orthoesters); poly(amino acids); and polyphosphazenes. Of these suitable polymers, aliphatic polyesters and polyanhydrides are preferred.

Suitable dehydrated compounds for use as solid particulates in the present invention may degrade over time as they are rehydrated. For example, a particulate solid anhydrous borate material that degrades over time may be suitable for use in the present invention. Specific examples of particulate solid anhydrous borate materials that may be used include, but are not limited to, anhydrous sodium tetraborate (also known as anhydrous borax) and anhydrous boric acid.

As described above, the gel particulate of a composite particulate of the present invention originates from a gel whose precursors are gelling agents. In some embodiments, the gel may be homogeneous or heterogeneous in composition and formed from one or more gelling agents. In some embodiments, the gelling agent may contain multiple monomer compositions, multiple partially polymerized monomer compositions, multiple partially crosslinked monomer compositions, or any combination thereof. In some embodiments, the gelling agents may be polymerized and/or crosslinked to form a gel. In some embodiments, the gelling agent may be polymerized by multiple methods of polymerization, crosslinked by multiple crosslinking agents, or any combination thereof. Suitable polymerization methods may include, but not be limited to, free radical polymerization, cationic polymerization, anionic polymerization, condensation polymerization, coordination catalyst polymerization, and hydrogen transfer polymerization. Further, polymerization may be done in any manner, e.g., solution polymerization, precipitation polymerization, suspension polymerization, emulsion polymerization, and bulk polymerization; these are known methods described in the literature.

In some embodiments, the gel particulate may be degradable. Suitable degradable gel particulates may be formed from any degradable gel suitable for use in a subterranean formation. In some embodiments, a secondary treatment fluid may be introduced into the wellbore to induce, retard, or enhance degradation of a degradable gel particulate.

Examples of suitable degradable gels and gelling agents may be “stimuli-degradable” and can be found in U.S. Pat. No. 7,306,040, the relevant disclosure of which is incorporated herein by reference. Stimuli that may lead to the degradation of stimuli-degradable gel particulates of the present invention include any change in the condition or properties of the gel including, but not limited to, a change in pH (e.g., caused by the buffering action of the rock or the decomposition of materials that release chemicals such as acids) or a change in the temperature (e.g., caused by the contact of the fluid with the rock formation).

To form stimuli-degradable gels, degradable crosslinkers may be used to crosslink gelling agents comprising “ethylenically unsaturated monomers.” Suitable gelling agents for stimuli-degradable gels include, but are not limited to, ionizable monomers (such as 1-N,N-diethylaminoethylmethacrylate); diallyldimethylammonium chloride; 2-acrylamido-2-methyl propane sulfonate; acrylic acid; allylic monomers (such as di-allyl phthalate; di-allyl maleate; allyl diglycol carbonate; and the like); vinyl formate; vinyl acetate; vinyl propionate; vinyl butyrate; crotonic acid; itaconic acid; acrylamide; methacrylamide; methacrylonitrile; acrolein; methyl vinyl ether; ethyl vinyl ether; vinyl ketone; ethyl vinyl ketone; allyl acetate; allyl propionate; diethyl maleate; any derivative thereof; and any combination thereof.

In some embodiments, the degradable crosslinker for use in stimuli-degradable gels may contain a degradable group(s) including, but not limited to, esters, phosphate esters, amides, acetals, ketals, orthoethers, carbonates, anhydrides, silyl ethers, alkene oxides, ethers, imines, ether esters, ester amides, ester urethanes, carbonate urethanes, amino acids, any derivative thereof, or any combination thereof. The choice of the degradable group may be determined by pH and temperature, the details of which are available in known literature sources. The unsaturated terminal groups may include substituted or unsubstituted ethylenically unsaturated groups, vinyl groups, allyl groups, acryl groups, or acryloyl groups, which are capable of undergoing polymerization with the above-mentioned gelling agents to form crosslinked stimuli-degradable gels. Suitable degradable crosslinkers for stimuli-degradable gels include, but are not limited to, unsaturated esters such as diacrylates, dimethacrylates, and dibutyl acrylates; acrylamides; ethers such as divinyl ethers; and combinations thereof. Specific examples include, but are not limited to, poly(ethylene glycol) diacrylate; polyethyleneglycol dimethacrylate; polyethyleneglycol divinyl ether; polyethylene glycol divinylamide; polypropylene glycol diglycidyl ether; polypropylene glycol diacrylate; poly(propylene glycol dimethacrylate); bisacrylamide; and combinations thereof. In one embodiment, a stimuli-degradable crosslinking agent comprises one or more degradable crosslink and two vinyl groups. Some embodiments of these crosslinking agents of the present invention are sensitive to changes in pH, such as orthoether-based embodiments, acetal-based embodiments, ketal-based embodiments, and silicon-based embodiments. Generally speaking, at room temperature, the ortho ester-based embodiments should be stable at pHs of above 10, and should degrade at a pH below about 9; the acetal-based embodiments should be stable at pHs above about 8 and should degrade at a pH below about 6; the ketal-based embodiments should be stable at pHs of about 7 and should degrade at a pH below 7; and the silicon-based embodiments should be stable at pHs above about 7 and should degrade faster in acidic media. Thus, under moderately acidic conditions (pH of around 3), the relative stability of these groups should decrease in the following order: amides>ketals>orthoether. At higher wellbore temperatures, the more stable crosslinking groups contain amides or ethers and would be preferred over other choices including esters, acetals, and ketals.

In some embodiments, the rate of degradation of a gel particulate may be controlled, at least in part, by a solid particulate incorporated therein. By way of non-limiting example, a gel particulate of polyacrylamide may have a calcium carbonate particulate incorporated therein. The calcium carbonate particulate may provide a local alkaline pH that allows the gel particulate to degrade more rapidly than it otherwise would an acidic local environment. Examples of solid particulates that may provide local pH control include, but are not limited to, calcium carbonate, calcium bicarbonate, calcium oxide, magnesium oxide, and magnesium hydroxide.

In some embodiments, composite particulates of the present invention may be implemented as a bridging agent, a fluid loss control agent, a diverting agent, or a plugging agent in a wellbore or subterranean formation.

Generally, as a treatment fluid is placed into a subterranean formation, it tends to dissipate into the subterranean zone through permeable rock, particulate packs, and openings, which may be naturally occurring (cracks, fractures, and fissures) or man-made (annulus between nested pipes, annulus between a wellbore and a pipe, wellbores, perforations, and fractures). Often, the dissipation is unwanted, and the loss of treatment fluid is known as “fluid loss.” To mitigate fluid loss, particulates may be placed into the treatment fluid in an attempt to plug the openings such that the treatment fluid can no longer dissipate through the openings.

Providing effective fluid loss control for subterranean treatment fluids is highly desirable. “Fluid loss,” as used herein, refers to the undesirable migration or loss of fluids (such as the fluid portion of a drilling mud or cement slurry) into a subterranean formation and/or a particulate pack. Treatment fluids may be used in any number of subterranean operations including, but not limited to, drilling operations, fracturing operations, acidizing operations, gravel-packing operations, workover operations, chemical treatment operations, wellbore clean-out operations, and the like. Fluid loss may be problematic in any number of these operations. In fracturing treatments, for example, fluid loss into the formation may result in a reduction in fluid efficiency, such that the fracturing fluid cannot propagate the fracture as desired. Fluid loss control materials are additives that lower the volume of a filtrate that passes through a filter medium. That is, they block the pore throats and spaces that otherwise allow a treatment fluid to leak out of a desired zone and into an undesired zone. Particulate materials may be used as fluid loss control materials in subterranean treatment fluids to fill/bridge the pore spaces in a formation matrix and/or proppant pack and/or to contact the surface of a formation face and/or proppant pack, thereby forming a type of filter cake that blocks the pore spaces in the formation or proppant pack, and prevents fluid loss therein. In some embodiments, when a composite particulate is used as a fluid loss control agent, it may be used in conjunction with a fracturing method. In some preferred embodiments the composite particulate may be used as a fluid loss control agent during the fracturing operation, that is, the composite particulate may be placed into a treatment fluid that is then placed into the portion of the subterranean formation at a pressure/rate sufficient to create or extend at least one fracture in that portion of the subterranean formation.

Diverting agents have similar actions but strive for a somewhat different approach. Diverting agents are used to seal off a portion of the subterranean formation. By way of example, in order to divert a treatment fluid from highly permeable portions of the formation into the less permeable portions of the formation, a volume of treatment fluid may be pumped into the formation followed by a diverting material to seal off a portion of the formation where the first treatment fluid penetrated. After the diverting material is placed, a second treatment fluid may be placed wherein the second treatment fluid will be diverted to a new zone for treatment by the previously placed diverting agent. When being placed, the treatment fluid containing the diverting agent will flow most readily into the portion of the formation having the largest pores, fissures, or vugs, until that portion is bridged and sealed, thus diverting the remaining fluid to the next most permeable portion of the formation. These steps may be repeated until the desired number of stages of treating fluid has been pumped. Generally, the methods of diverting using a composite particulate of the present invention are preformed at or below matrix flow rates; that is, flow rates and pressures that are below the rate/pressure sufficient to create or extend fractures in that portion of a subterranean formation.

Plugging, or sealing, agents are similar to diverting agents. Whereas diverting agents are used to seal off a portion of the subterranean formation, plugging agents are used to seal off a wellbore or provide zonal isolation. When a particulate plugging agent is used, the effect is similar to that of a diverting agent in that a fluid is placed having the plugging agent therein and the plugging agent seals the wellbore face such that fluid cannot enter the permeable zones until the plugging agent is removed. In some embodiments, it may be desirable to use a composite particulate of the present invention in zonal isolation by completely filling a portion of an annulus along a wellbore or by filling a fracture extending from a wellbore. By way of nonlimiting example, a composite particulate comprising stimuli-degradable gel particulates with calcium carbonate solid particulates incorporated therein may be placed in a horizontal well penetrating a shale formation. The composite particulate may provide temporary zonal isolation within the wellbore to allow for treating a different zone within the wellbore. The composite particulates may degrade over time, e.g., within a few days, without the assistance of a secondary fluid to enhance degradation. Then the previously isolated zone may be further treated as desired, e.g., given an acid treatment. Another example may be composite particulates used to seal structural components within a wellbore including, but not limited to, an annulus, ports, casing slots, pipe slots, screens, and any combination thereof. In such embodiments, large quantities of the composite particulate will likely be required in order to completely close a flow path rather than simply block pore throats or rock faces.

Whether using the composite particulate as a bridging agent, a fluid loss control agent, a diverting agent, or a plugging agent, the composite particulate is preferably included in the treatment fluid comprising a base fluid in an amount ranging from a lower limit of about 1%, 5%, 10%, 20%, or 30% to an upper limit of about 60%, 50%, 40%, 30%, or 20% weight per volume (W/V) of treatment fluid, and wherein the amount may range from any lower limit to any upper limit and encompass any subset between the upper and lower limits. In certain embodiments, relatively high loading of composite particulate into the treatment fluid allows for a sufficient quantity of composite particulate to act to plug a space, control fluid loss, or divert fluids as desired.

Suitable base fluids include, but are not limited to, aqueous-based fluids and oil-based fluids. In some embodiments, the base fluid may be emulsified or foamed. In some embodiments, the base fluid may comprise a water miscible polar solvent, e.g., an alcohol, an ether, and any combination thereof. One skilled in the art, with the benefit of this disclosure, would understand the available base fluids that are compatible with a desired composite particulate for use in a subterranean formation.

Suitable aqueous base fluids may include, but not be limited to, fresh water, salt water, brine (saturated salt water), seawater, produced water (subterranean formation water brought to the surface), surface water (such as lake or river water), and flow back water (water placed into a subterranean formation and then brought back to the surface). In some embodiments mine drainage water may also be used. Mine drainage water as used herein includes: acid mine drainage water, alkaline mine drainage water, and metal mine drainage water. Acid mine drainage water is water contaminated when pyrite, an iron sulfide, is exposed and reacts with air and water to form sulfuric acid and dissolved iron. Acid mine drainage water is often associated with the outflow of acidic water from metal mines or coal mines; but it may also come from other sources such as where the earth has been disturbed, liquid that drains from coal stocks, coal handling facilities, and the like. Alkaline mine drainage water is alkaline water contaminated often with high levels of metals; often the rock that produces alkaline drainage water has calcite and/or dolomite present. Metal mine drainage water is water contaminated with metals and is often from mines that produce or have produced lead, gold, and other metals,

When the base fluid is an aqueous acid solution, the aqueous acid solution can include one or more acids such as hydrochloric acid, hydrofluoric acid, acetic acid, formic acid, and other organic acids. For example, in acidizing procedures for restoring the permeability of subterranean producing zones, a mixture of hydrochloric and hydrofluoric acids is commonly used in sandstone formations.

In some embodiments, the viscosity of the aqueous base fluid can be adjusted, among other purposes, to provide additional particulate transport and suspension in the base fluid used in the methods of the present invention. The treatment fluid may be gelled, or gelled and crosslinked, to increase its solids carrying capacity. In certain embodiments, the pH of an aqueous base fluid may be adjusted (e.g., by a buffer or other pH adjusting agent), among other purposes, to activate a crosslinking agent and/or to reduce the viscosity of the treatment fluid (e.g., activate a breaker, deactivate a crosslinking agent). In these embodiments, the pH may be adjusted to a specific level, which may depend on, among other factors, the types of diverting agents and other additives included in the treatment fluid. One of ordinary skill in the art, with the benefit of this disclosure, will recognize when such density and/or pH adjustments are appropriate.

The methods of the present invention may be used in many different types of subterranean treatment operations. Such operations include, but are not limited to, acidizing operations, scale inhibiting operations, water blocking operations, clay stabilizer operations, biocide operations, fracturing operations, frac-packing operations, and gravel packing operations. By way of nonlimiting example, a treatment fluid comprising the composite particulate may be placed into a subterranean formation at an operating pressure below, at, or above matrix pressure. As used herein, the term “matrix pressure” refers to a pressure just below a pressure that would cause the subterranean formation to fracture.

in some embodiments, whether for fracturing operations or other operations, a composite particulate may be introduced into a wellbore or subterranean formation at a differential pressure ranging from a lower limit of about 50 psi, 150 psi, or 250 psi to an upper limit of about 2000 psi, 1500 psi, 1000 psi, 750 psi, 500 psi, or 250 psi, and wherein the differential pressure may range from any lower limit to any upper limit and encompass any subset between the upper and lower limits. As used herein, the term “differential pressure” refers to the difference between two pressure measurements, e,g., for production wells between the average reservoir pressure and the bottomhole pressure and for injection wells between the injection pressure and the average reservoir pressure. One skilled in the art would understand the two pressure measurements to consider given a particular wellbore operation and/or a particular implementation of a composite particle. By way of nonlimiting example, when applying a composite particulate as a bridging agent in a filter cake, differential pressure may be the pressure difference across the filter cake.

The composite particulates of the present invention may be used in full-scale operations or pills. As used herein, a “pill” is a type of treatment of relatively small volume of specially prepared treatment fluid placed or circulated in the wellbore.

Depending on the use of the treatment fluid, in some embodiments, other additives may optionally be included in the treatment fluids of the present invention. Examples of such additives may include, but are not limited to, salts, pH control additives, surfactants, foaming agents, breakers, biocides, crosslinkers, additional fluid loss control agents, stabilizers, chelating agents, scale inhibitors, gases, mutual solvents, particulates, corrosion inhibitors, oxidizers, reducers, viscosifying agents, proppants particulates, gravel particulates, and any combination thereof. A person of ordinary skill in the art, with the benefit of this disclosure, will recognize when such optional additives should be included in a treatment fluid used in the present invention, as well as the appropriate amounts of those additives to include.

In some embodiments, a treatment fluid generally contains a base fluid and a composite particulate. The composite particulate may generally include a gel particulate that is degradable having a solid particulate incorporated therein. Using the treatment fluid in a subterranean formation may include introducing the treatment fluid into a wellbore penetrating a subterranean formation and allowing the composite particulate to bridge a fracture, provide fluid loss control, seal a rock surface for fluid diversion, or plug a void within the wellbore or the subterranean formation.

In some embodiments, a treatment fluid generally contains a base fluid and a composite particulate. The composite particulate may generally include a gel particulate having a solid particulate incorporated therein. Using the treatment fluid in a subterranean formation may include introducing the treatment fluid into a wellbore penetrating a subterranean formation; allowing the composite particulate to bridge a fracture, provide fluid loss control, seal a rock surface for fluid diversion, or plug a void within the wellbore or the subterranean formation; and allowing the gel particulate to degrade over time in the subterranean formation such that the composite particulate at some time no longer functions to bridge the fracture, provide fluid loss control, seal the rock surface for fluid diversion, or plug the void within the wellbore or the subterranean formation.

In some embodiments, a composite particulate may generally include a gel particulate having a solid particulate incorporated therein.

To facilitate a better understanding of the present invention, the following examples of preferred embodiments are given. In no way should the following examples be read to limit, or to define, the scope of the invention.

### EXAMPLES

Both examples provided herein use the apparatus shown in FIG. 3 to measure fluid loss as a function of time and pressure. The apparatus comprises a stirring motor 301, a vessel for holding test fluids 302, a thin aluminum membrane 303, a Hassler sleeve 304, a tapered core 305, a valve to shut off the applied pressure 306, a measuring cylinder 307, a mass balance 308, a gas inlet to apply pressure to the fluid 309, and a gas inlet to apply confining pressure to the Hassler sleeve 310. The tapered core is an Ohio sandstone with a tapered fracture through the length that measures 6 inches in length and 1.5 mm in width where the fluid is introduced that tapers down to a 0.5 mm in width where the fluid exits.

### Example 1

The fluid loss characteristics of compositions including polyacrylamide/poly(ethylene glycol) diacrylate gel particulates and poly(lactic acid) solid particulates were compared. First, 4% acrylamide and 1% poly(ethylene glycol) diacrylate (mol mass 700) was polymerized with potassium persulfate at room temperature with activator tetra methyl ethylene diamine to form a gel. The gel (30 g) was then chopped in water (150 mL) into gel particulates with about 1-3 mm diameter using a Silverson emulsifier. The gel particulates were then suspended in water (250 mL) with stirring. The resultant suspension was run through the apparatus described above and shown in FIG. 3. Sample A, an example of a gel particulate having a solid particulate incorporated, was prepared such that poly(lactic acid) solid particulates were suspended in the polyacrylamide/poly(ethylene glycol) diacrylate before polymerization in an amount of 10% w/w. Sample B, an example of a gel particulate and a solid particulate admixed, was prepared by adding poly(lactic acid) solid particulates to the polyacrylamide/poly(ethylene glycol) diacrylate gel particulates after being chopped in an amount of 10% w/w, Sample C, an example of gel particulates only, was prepared without the addition of poly(lactic acid) solid particulates.

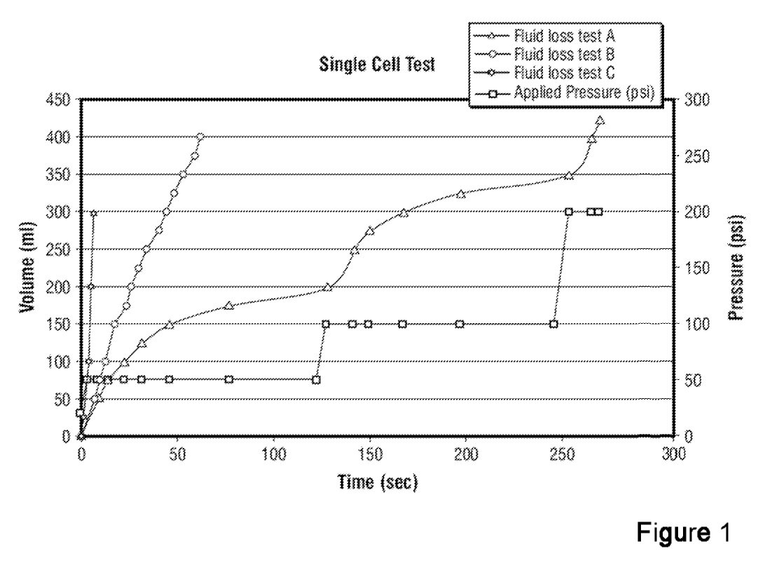

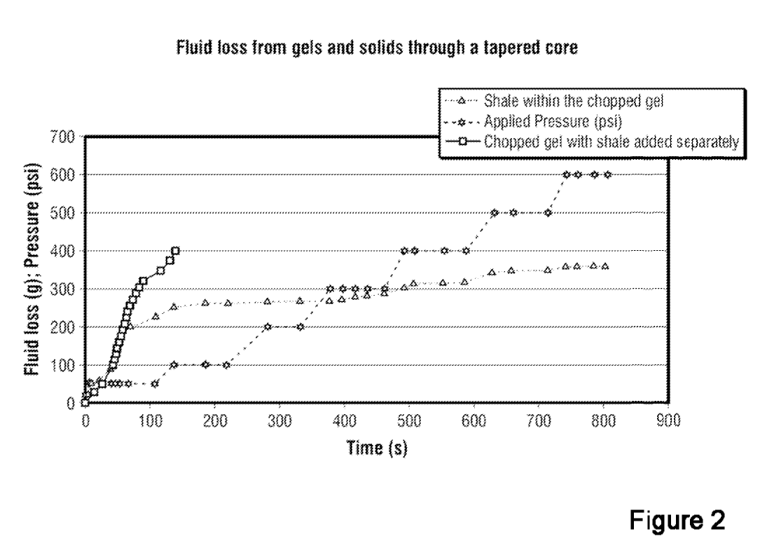

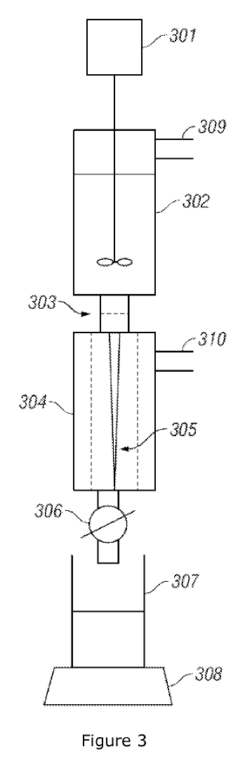

As presented in FIG. 1, the gel particulates with no solid particulates allowed water to pass through the core sample at a steady, rapid pace at below 50 psi. For the gel particulates admixed with the solid particulates, the water passed through the core sample at a steady, rapid pace at 50 psi with no leveling or stabilization. The gel particulates having solid particulates incorporated demonstrated the highest fluid loss control by hindering water flow through the core sample up to 200 psi.

### Example 2

The fluid loss characteristics of compositions including polyacyamide/poly(ethylene glycol) diacrylate gel particulates and vitrified shale solid particulates (0.64.0 mm diameter) were compared. 6% acrylamide and 1% poly(ethylene glycol) diacrylate were polymerized, chopped to 2-5 mm diameter particles, suspended, and tested as described in Example 1. Sample A, an example of a gel particulate having a solid particulate incorporated, was prepared such that vitrified shale solid particulates were suspended in the polyacrylamide/poly(ethylene glycol) diacrylate before polymerization in an amount of 10% w/w. Sample B, an example of a gel particulate and a solid particulate admixed, was prepared by adding vitrified shale solid particulates to the polyacrylamide/poly(ethylene glycol) diacrylate gel particulates after being chopped in an amount of 1.0% w/w.

As presented in FIG. 2, the gel particulates admixed with the solid particulates show no fluid loss control above 100 psi, The gel particulates having solid particulates incorporated demonstrated fluid loss control by hindering water flow through the core sample up through 600 psi.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. While compositions and methods are described in terms of “comprising,” “containing,” or “including” various components or steps, the compositions and methods can also “consist essentially of” or consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may he incorporated herein by reference, the definitions that are consistent with this specification should be adopted.

What is claimed is:

1. A method comprising:
introducing a treatment fluid comprising a base fluid and a composite particulate into a wellbore penetrating a subterranean formation,
wherein the composite particulate comprises a gel particulate having a solid particulate incorporated therein; and
allowing the composite particulate to bridge a fracture, provide fluid loss control, seal a rock surface for fluid diversion, or plug a void within the wellbore or the subterranean formation.

2. The method of claim 1, wherein at least a portion of the subterranean formation has a permeability greater than about 0.5 D.

3. The method of claim 1, further comprising operating the wellbore at a differential pressure ranging from about 50 psi to about 2000 psi,

4. The method of claim 1, wherein at least either the solid particulate or the gel particulate are degradable.

5. The method of claim 1, wherein the gel particulate is degradable and the solid particulate therein effects the rate at which the gel particulate degrades.

6. The method of claim 1, wherein the gel particulate has one or more solid particulates incorporated therein,

7. The method of claim 6, wherein the one or more solid particulates are of one or more chemical compositions.

8. The method of claim 1, wherein the composite particulate becomes incorporated into a filter cake either during the filter cake formation or after the filter cake is formed.

9. The method of claim 1, wherein the composite particulate is present in the treatment fluid at a concentration of about 2% to about 80% weight per volume of treatment fluid.

10. A method comprising:
introducing a treatment fluid comprising a base fluid and a composite particulate into a wellbore penetrating a subterranean formation,
wherein the composite particulate comprises a gel particulate having a solid particulate incorporated therein, and
wherein the gel particulate is degradable;
allowing the composite particulate to bridge a fracture, provide fluid loss control, seal a rock surface for fluid diversion, or plug a void within the wellbore or the subterranean formation; and
allowing the gel particulate to degrade over time in the subterranean formation such that the composite particulate at some time no longer functions to bridge the fracture, provide fluid loss control, seal the rock surface for fluid diversion, or plug the void within the wellbore or the subterranean formation.

11. The method of claim 10, wherein at least a portion of the subterranean formation has a permeability greater than about 0.5 D.

12. The method of claim 10, wherein the gel particulate has one or more solid particulates incorporated.

13. The method of claim 12, wherein the one or more solid particulates are of one or more chemical compositions.

14. The method of claim 10, wherein the gel particulate is stimuli-degradable,

15. The method of claim 10 further comprising:
contacting the composite particulate with a second treatment fluid to initiate, retard, or enhance the rate of degradation of the gel particulate.

16. The method of claim 10, wherein the solid particulate within the gel particulate effects the rate at which the gel particulate degrades.

17. A composite particulate comprising a gel particulate having a solid particulate incorporated therein.

18. The composite particulate of claim 17, wherein at least either the solid particulate or the gel particulate are degradable.

19. The composite particulate of claim 17, wherein the gel particulate is degradable and the solid particulate therein effects the rate at which the gel particulate degrades.

20. The composite particulate of claim 17, wherein the gel particulate has one or more solid particulates incorporated therein.
